(19) United States
(12) Patent Application Publication
(10) Pub. No.: US 2010/0138894 A1
(43) Pub. Date: Jun. 3, 2010

(54) INFORMATION PROCESSING APPARATUS, INFORMATION PROCESSING METHOD, AND COMPUTER READABLE MEDIUM

(75) Inventor: Masaki KYOJIMA, Tokyo (JP)

Correspondence Address: SUGHRUE-265550, 2100 PENNSYLVANIA AVE. NW, WASHINGTON, DC, 20037-3213, US

(73) Assignee: Fuji Xerox Co., Ltd., Tokyo (JP)

(21) Appl. No.: 12/432,456

(22) Filed: Apr. 29, 2009

(30) Foreign Application Priority Data
Dec. 3, 2008 (JP) 2008-308363

(51) Int. Cl. G06F 21/00

(52) U.S. Cl. 726/1; 726/26

(57) ABSTRACT

An information processing apparatus includes: a storage that associates each of a plurality of pieces of use limitation information with a characteristic information, and that stores each of the plurality of pieces of use limitation information and the characteristic information, which are associated with each other; and a selection unit that refers to the storage, and that selects, based on a result of comparison between a second document characteristic information of a document acquired from a specified document specified by and in response to an instruction specifying a document for which a policy for limitation on use is to be determined and the characteristic information associated with each of the plurality of pieces of use limitation information stored in the storage, a candidate for use limitation information to be used for the limitation on use of the specified document from the plurality of pieces of use limitation information.

### CROSS-REFERENCE TO RELATED APPLICATIONS

This application is based on and claims priority under 35 U.S.C. 119 from Japanese Patent Application No. 2008-308363 filed Dec. 3, 2008.

### BACKGROUND

1. Technical Field

The present invention relates to an information processing apparatus, an information processing method, and a computer readable medium.

2. Related Art

There is a technique which prevents illegal use of a document by limiting the use of the document in accordance with a security policy (hereinafter simply referred to as a “policy”) defining a policy for limitation on use of the document. In the technique, the policy is set for each target document of which the use is to be limited, and the use of the target document is limited in accordance with the policy. The policy set for the document indicates, e.g., types of operations approved or disapproved for the execution of each user or user group, a valid period in which the use of the document is approved, and the like. In some cases, to set the policy used for the limitation on the use of the document is referred to as an “application” of the policy to the document.

In some cases, plural policies are defined in accordance with a request for security to be protected during the use of the document. For example, different types of policies are defined in accordance with a degree of a thereat posed when the document is illegally used, and in accordance with an area of people involved in the document. When a plurality of policies are defined, for example, processing is performed in which the plurality of policies are registered in a server in advance, one of the policies registered in the server is selected for a target document of which the use is to be limited, and the selected policy is applied to the target document.

### SUMMARY

According to an aspect of the present invention, an information processing apparatus includes: a storage that associates each of a plurality of pieces of use limitation information, which defines a policy for limitation on use of each of a plurality of documents, with a characteristic information, which represents a characteristic of each of the plurality of pieces of use limitation information and is determined based on a first document characteristic information acquired from each of the plurality of documents of which the use is limited according to the plurality of pieces of use limitation information, and that stores each of the plurality of pieces of use limitation information and the characteristic information, which are associated with each other; and a selection unit that refers to the storage, and that selects, based on a result of comparison between a second document characteristic information of a document acquired from a specified document specified by and in response to an instruction specifying a document for which the policy for limitation on use is to be determined and the characteristic information associated with each of the plurality of pieces of use limitation information stored in the storage, a candidate for use limitation information to be used for the limitation on use of the specified document from the plurality of pieces of use limitation information.

### BRIEF DESCRIPTION OF THE DRAWINGS

Exemplary embodiment of the present invention will be described in detail based on the following figures, wherein:

FIG. 1 is a block diagram showing an example of a schematic structure of a system for managing use of a document;

FIG. 2 is a block diagram showing an example of a schematic internal structure of a policy server;

FIG. 3 is a view showing an example of a content of a policy to be registered in a policy information DB;

FIG. 4 is a view showing an example of characteristic information of each policy to be registered in the policy DB;

FIG. 5 is a view showing an example of the setting of index words;

FIG. 6 is a view showing an example of a data content of a document information DB;

FIG. 7 is a conceptual view illustrating a relation between a set of characteristic information items of documents to which a policy is applied and the characteristic information of the policy;

FIG. 8 is a block diagram showing an example of a schematic internal structure of a client;

FIG. 9 is a flow chart showing an example of a procedure of processing performed in the policy server when the policy is applied to the document;

FIG. 10 is a flow chart showing an example of a procedure of processing performed in the client when a user uses the document to which the policy is applied;

FIG. 11 is a flow chart showing an example of a procedure of processing performed in the policy server when the user uses the document to which the policy is applied;

FIG. 12 is a conceptual view illustrating another example of the relation between the set of the characteristic information items of the documents to which a policy is applied and the characteristic information of the policy;

FIG. 13 is a view showing another example of the characteristic information of each policy to be registered in the policy information DB;

FIG. 14 is a view showing another example of the data content in the document information DB;

FIG. 15 is a block diagram showing another example of the schematic internal structure of the client;

FIG. 16 is a block diagram showing another example of the schematic internal structure of the policy server;

FIG. 17 is a flow chart showing an example of another procedure of the processing performed in the client and the policy server when the policy is applied to the document; and

FIG. 18 is a view showing an example of a hardware structure of a computer.

### DETAILED DESCRIPTION

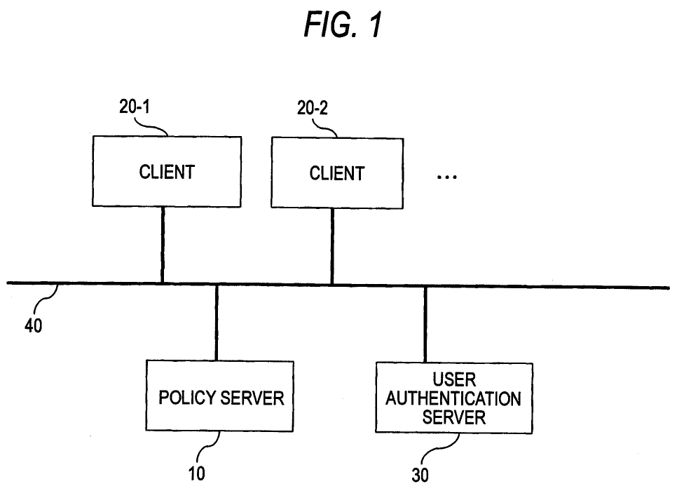

FIG. 1 shows an example of a schematic structure of a system for managing use of a document. The system exemplified in FIG. 1 has a structure in which a policy server 10, clients 20-1, 20-2, . . . (hereinafter collectively referred to as client 20), and a user authentication server 30 are connected with each other via a network 40.

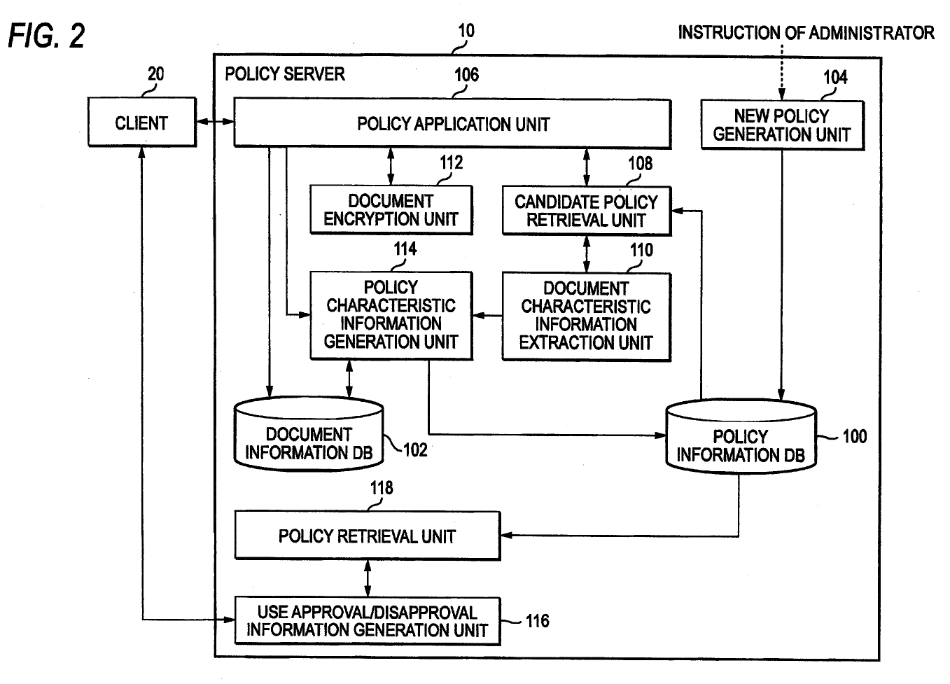

FIG. 2 shows an example of a schematic internal structure of the policy server 10. The policy server 10 manages policies used for limitation on use of a document in the present system. The policy server 10 includes a policy information DB (database) 100, a document information DB 102, a new policy generation unit 104, a policy application unit 106, a candidate policy retrieval unit 108, a document characteristic information extraction unit 110, a document encryption unit 112, a policy characteristic information generation unit 114, a use approval/disapproval information generation unit 116, and a policy retrieval unit 118.

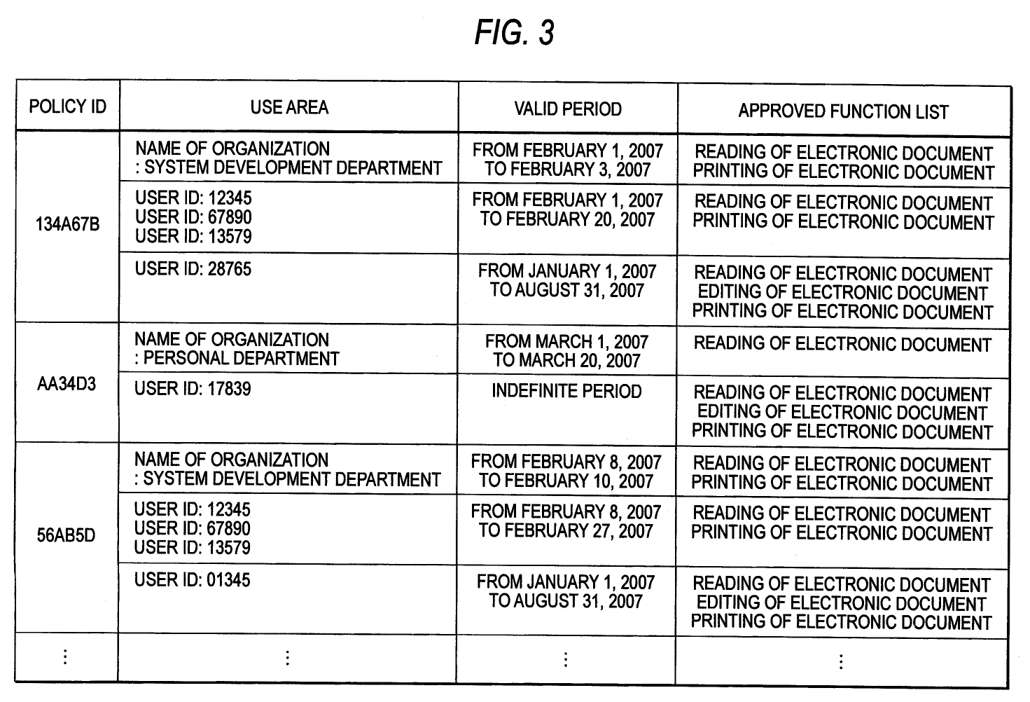

The policy information DB 100 is a database for storing information related to policies to be managed by the policy server 10. FIG. 3 shows an example of contents of policies to be registered in the policy information DB 100.

Referring to FIG. 3, each policy is defined according to respective items of a policy ID, a use area, a valid period, and an approved function list. The policy ID is identification information assigned to each policy which is unique in the system. The use area represents an executer actually executing operations with respect to a document, and is indicated by the identification information of a user or a group (a user ID, a name of an organization to which the user belongs, or the like). The valid period represents a period in which the user or the group indicated by the corresponding use area can use the document. The approved function list shows types of operations approved for the execution of the user or the group indicated by the corresponding use area. For example, when a document to which a policy indicated by the policy ID “134A67B” in the table in the example of FIG. 3 is applied is used by the user belonging to the name of the organization “system development department”, execution of the operations of “reading of electronic document” and “printing of electronic document” is approved in the valid period “from Feb. 1, 2007 to Feb. 3, 2007”.

It is to be noted that the content of the policy is not limited to the implementation exemplified in FIG. 3. For example, as an item that is not shown in the table of the example of FIG. 3, a name of a policy given to the policy by a system manager or the like may be registered. In addition, for example, instead of registering the approved function list in correspondence to the executer of each use area, the types of operations which are disapproved may be registered or setting information that explicitly shows both of the types of operations that are approved and the types of operations that are disapproved may be registered.

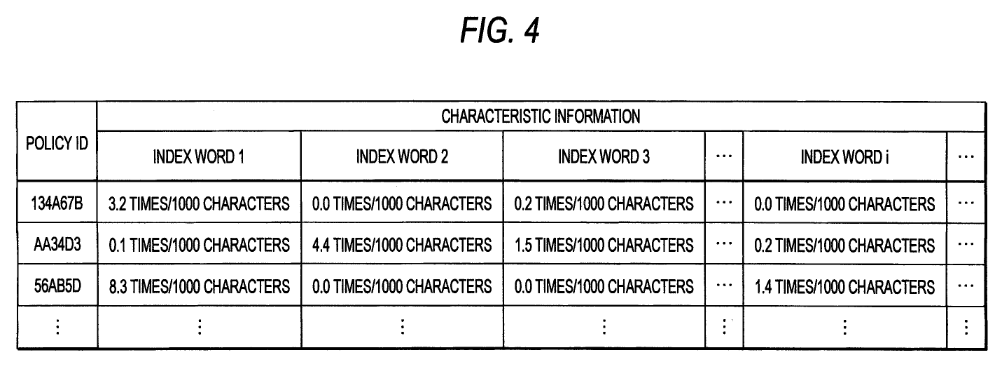

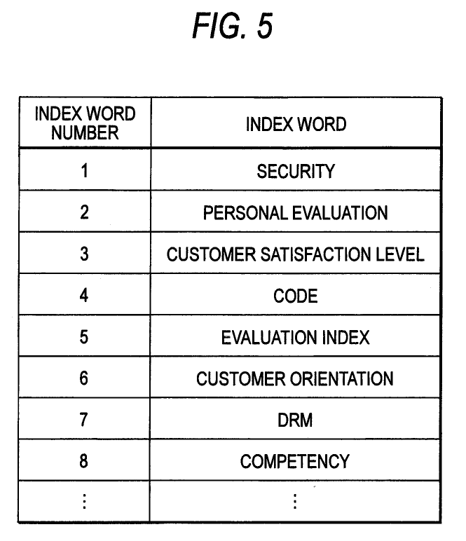

In the example of the present embodiment, the policy information DB 100 stores characteristic information representing a characteristic of each policy in addition to the content of each policy exemplified in FIG. 3. The characteristic information of each policy is determined by using characteristic information of a document obtained from the document to which the policy is applied (i.e., the document of which the use is limited according to the policy). FIG. 4 shows an example of the characteristic information of each policy stored in the policy information DB 100. Referring to FIG. 4, the policy information DB 100 stores the characteristic information of the policy in correspondence to the policy ID for each policy. In a table in the example of FIG. 4, an item of the characteristic information includes “index word 1”, “index word 2”, . . . , “index word i”, . . . as subitems. The index word used herein refers to a word preset as a word suitable for determining the tendency of the content of the document. For example, the i-th index word (index word i) is preset in a manner as shown in the table in the example of FIG. 5, and is stored in another storage device that can be accessed by the policy information DB 100 or the policy server 10. Returning back to the reference to FIG. 4, in the item of “index word i”, an appearance frequency of the index word (for example, the number of times of appearance of the index word per 1000 characters) in the content of the document is determined for each of the documents to which the corresponding policy is applied, and an average value of the determined appearance frequencies is registered.

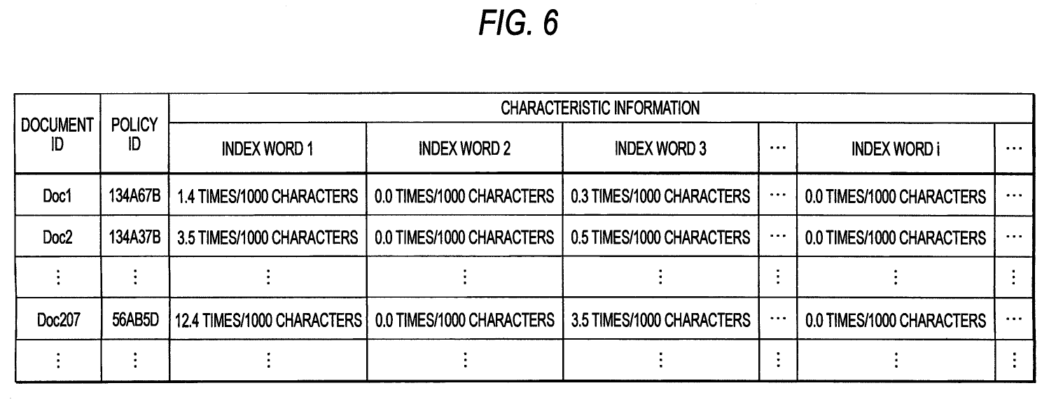

Information for specifying a document to which each policy is applied and the characteristic information of each document are stored in the document information DB 102. The document information DB 102 is a database for storing information related to the document to which the policy is applied. FIG. 6 shows one example of a data content of the document information DB 102. Each row in the table in the example of FIG. 6 is a record in correspondence to the information related to one document. Referring to FIG. 6, the record in correspondence to each document includes respective items of a document ID, a policy ID, and characteristic information. The document ID is identification information assigned to each document which is unique in the system. The policy ID is an ID for the policy applied to the document in the corresponding record. The characteristic information is characteristic information acquired from the document in the corresponding record. The item of the characteristic information in the example of FIG. 6 includes “index word i” as the subitem, and each index word corresponds to each index word representing the characteristic information of the policy shown in the table in the example of FIG. 4.

Referring to FIGS. 4 and 6, for example, the characteristic information of the policy indicated by the policy ID “134A67B” (the second row in the table of FIG. 4) is obtained by extracting a record including “134A67B” in the item of the policy ID in the document information DB 102, and calculating an average of values in the respective items of the index words in the extracted record.

The relation between the characteristic information of the policy and the characteristic information of each document that have been described thus far can be described, e.g., as follows. When n index words are preset, mₚ documents to which a certain policy P is applied exist, and the appearance frequency of the i-th index word in the j-th document is f_{i•j}, the characteristic information η (P) of the policy P is represented by following Expression (1):

$$\begin{matrix}η ( P ) = ( {F}_{1} , {F}_{2} , … , {F}_{n} ) \\ wherein & ( 1 ) \\ {F}_{i} = \frac{{\sum }_{j = 1}^{{m}_{p}} {f}_{i , j}}{{m}_{p}} . & ( 2 )\end{matrix}$$

According to Expressions (1) and (2), it can be said that the characteristic information η (P) of the policy P is an average of a vector of the characteristic information λ (j)=(f_{1•j•}, f_{2•j}, . . . , f_{n•j}) of the document j (j=1, 2, . . . , mₚ) to which the policy P is applied.

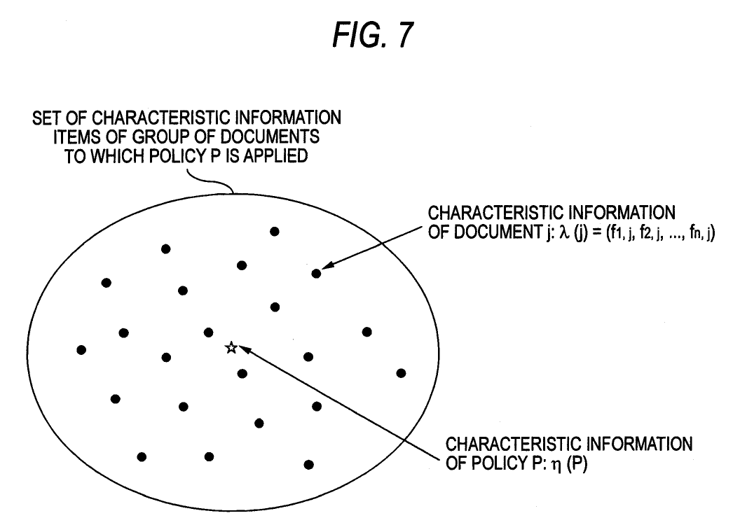

FIG. 7 shows an example of a conceptual view showing the relation between the characteristic information η (P) of the policy P determined using Expressions (1) and (2) and a set of the characteristic information λ (j) of the document j. It can be said that the characteristic information η (P) of the policy P represents a representative element in the set of the characteristic information λ (j) of the document j to which the policy P is applied.

Returning back to the description of FIG. 2, the new policy generation unit 104 generates a new policy according to an instruction from a system manager or the like. For example, the new policy generation unit 104 receives the instruction for setting the content of a new policy (e.g., use area, valid period, approved function list, or the like), and generates a new policy ID for the policy. Then, the new policy generation unit 104 registers the policy content indicated by the received instruction for setting in the policy information DB 100 in association with the generated policy ID.

The policy application unit 106 performs a process for applying a policy to a document to which the policy is not applied. For example, on receiving a request for applying a policy including a target document to which the policy is to be applied (hereinafter also referred to as a “application target document”) from the client 20, the policy application unit 106 requests the candidate policy retrieval unit 108 to retrieve applicable candidate policies from the policy information DB 100, and performs a process for applying one policy among the retrieved candidate policies to the application target document. In the process for applying the policy, the policy application unit 106, e.g., causes the document encryption unit 112 to encrypt the application target document, and writes the policy ID for the applied policy into the encrypted document. Thus, the document which is encrypted and the policy ID is written into is transmitted as the document to which the policy is applied from the policy application unit 106 to the client 20.

On receiving the request from the policy application unit 106, the candidate policy retrieval unit 108 retrieves candidate policies to be applied to the application target document from the policy information DB 100. For example, the candidate policy retrieval unit 108 selects the candidate policies to be applied from the policies in the policy information DB 100 based on a result of comparison between the characteristic information of each policy registered in the policy information DB 100 and the characteristic information of the document extracted from the application target document by requesting the document characteristic information extraction unit 110. Then, the candidate policy retrieval unit 108 returns the selected candidate policies to the policy application unit 106 as the retrieval result.

The document characteristic information extraction unit 110 extracts, from the application target document, the characteristic information of the document in response to the request from the candidate policy retrieval unit 108. In the case of the above-mentioned example in which the appearance frequency of the index word is used as the characteristic information, for example, the document characteristic information extraction unit 110 determines the appearance frequency of each of the index words by referring to the table for setting the index words (see FIG. 5) and retrieving text data of the application target document for each of the index words of individual numbers. The determined appearance frequency of each word is passed to the candidate policy retrieval unit 108 as the characteristic information of the application target document.

The document encryption unit 112 encrypts the application target document according to the instruction of the policy application unit 106 and returns the encrypted document to the policy application unit 106.

The policy characteristic information generation unit 114 generates the characteristic information of each of the policies registered in the policy information DB 100. For example, the policy characteristic information generation unit 114 refers to the document information DB 102, determines, from the characteristic information items of a plurality of documents to which the same policy is applied, the characteristic information of the policy according to Expressions (1) and (2), and registers the determined characteristic information in association with the policy ID for the policy in the policy information DB 100. In addition, for example, by using the characteristic information of the document to which the policy is newly applied by the policy application unit 106, the policy characteristic information generation unit 114 sometimes performs a process for updating the characteristic information of the applied policy registered in the policy information DB 100.

In response to a use request of the document to which the policy is applied from the client 20, the use approval/disapproval information generation unit 116 generates information indicative of approval or disapproval for the use of the document. The use request includes, e.g., the policy ID included in the document to which the policy is applied, the identification information of the user who has issued the use request, and information indicative of the type of the requested operation. For example, on receiving the use request from the client 20, the use approval/disapproval information generation unit 116 causes the policy retrieval unit 118 to retrieve the policy indicated by the policy ID included in the use request, and determines approval or disapproval for the use of the requested document by checking the content of the policy as the retrieval result against the user who has issued the use request and the type of the requested operation. The information indicative of the determination is returned to the client 20 as the request source.

The policy retrieval unit 118 retrieves the policy indicated by the policy ID specified by the use approval/disapproval information generation unit 116 from the policy information DB 100, and passes the content of the policy as the retrieval result to the use approval/disapproval information generation unit 116.

In the foregoing description, it has been described that the policy information DB 100 and the document information DB 102 are provided in the policy server 10. However, a part or all of the data contents of the policy information DB 100 and the document information DB 102 may be implemented in a memory device provided in another computer that can be accessed from a sever device for implementing the functions of other individual units of the policy server 10.

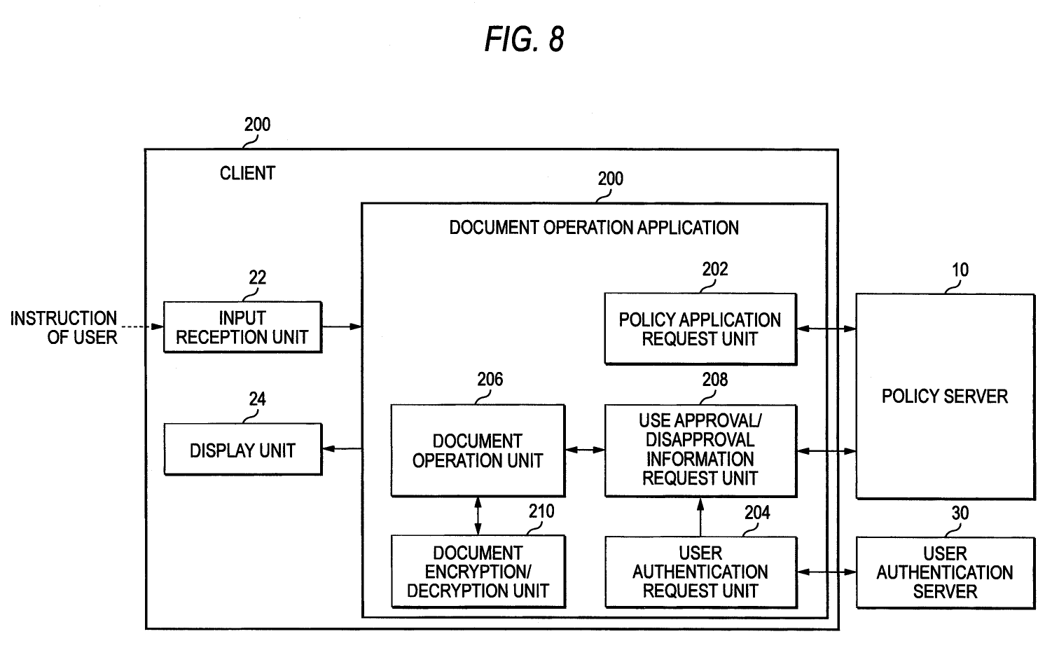

Next, with reference to FIG. 8, a description will be given of an example of a schematic internal structure of the client 20. The client 20 includes an input reception unit 22, a display unit 24, and a document operation application 200.

The input reception unit 22 receives information inputted by the user via an input device (not shown) such as a keyboard, a mouse, or the like, and passes the received input information to the document operation application 200.

The display unit 24 displays information to be presented to the user.

The document operation application 200 performs a process for applying a policy to a document to which the policy is not applied, and executes an operation with respect to a document to which the policy is applied. The document operation application 200 includes a policy application request unit 202, a user authentication request unit 204, a document operation unit 206, a use approval/disapproval information request unit 208, and a document encryption/decryption unit 210.

The policy application request unit 202 requests the policy server 10 to apply a policy to a document to which the policy is not applied according to the instruction from the user which is acquired via the input reception unit 22. For example, the policy application request unit 202 transmits a policy application request including a document to which the application of the policy is instructed by the user as the application target document to the policy server 10.

The user authentication request unit 204 makes a user authentication request to the user authentication server 30 by using authentication information (e.g., the user ID and a password) acquired via the input reception unit 22, and passes the authentication result returned from the user authentication server 30 in response to the request to the use approval/disapproval information request unit 208 that will be described later.

The document operation unit 206 executes various operations with respect to the document to which the policy is applied. Examples of the operations with respect to the document include, e.g., displaying of the document content on the display unit 24 (“reading” of the document for the user), editing of the document content, copying of the document, printing of the document (instruction for printing the document given to a printer that is not shown), scanning of the document (scanning of the document by a scanner device that is not shown), and the like. The document operation unit 206 executes the operations with respect to the document only when the use approval/disapproval information request unit 208, which will be described next, inquires whether the execution of the operations with respect to the document to which the policy is applied is approved or disapproved of the policy server 10, and the execution is approved as the result of the inquiry.

On receiving a request for execution of the operations with respect to the document to which the policy is applied from the user via the input reception unit 22, the use approval/disapproval information request unit 208 inquires whether the execution of the operations is approved or disapproved of the policy server 10. For example, the use approval/disapproval information request unit 208 extracts, from the document to which the policy is applied which is the target document to be operated, the policy ID included in the document, and transmits a use approval/disapproval information request including the policy ID, the user ID indicated by the result of the user authentication acquired from the user authentication request unit 204, and the type of the requested operation to the policy server 10. Subsequently, the use approval/disapproval information request unit 208 passes use approval/disapproval information returned in response to the request from the policy server 10 to the document operation unit 206.

The document encryption/decryption unit 210 performs a process for encrypting or decrypting the document to which the policy is applied. For example, the document encryption/decryption unit 210 encrypts the document obtained as the result of the operation such as the editing or the like performed by the document operation unit 206, and decrypts the document to which the policy is applied.

The user authentication server 30 manages the authentication information of users registered in advance as the users of the present system, and performs the user authentication. On receiving the input of the authentication information such as the user ID and the password, the user authentication request unit 204 of the client 20 transmits the received information to the user authentication server 30 to perform the user authentication request, as described above. In response to the request, the user authentication server 30 performs the user authentication, and returns the result of the user authentication to the device as the request source. In addition, the user authentication server 30 manages information for associating a user group with users belonging to the user group.

A description will be given hereinafter of an example of processing performed in the system having the structure in the example described above.

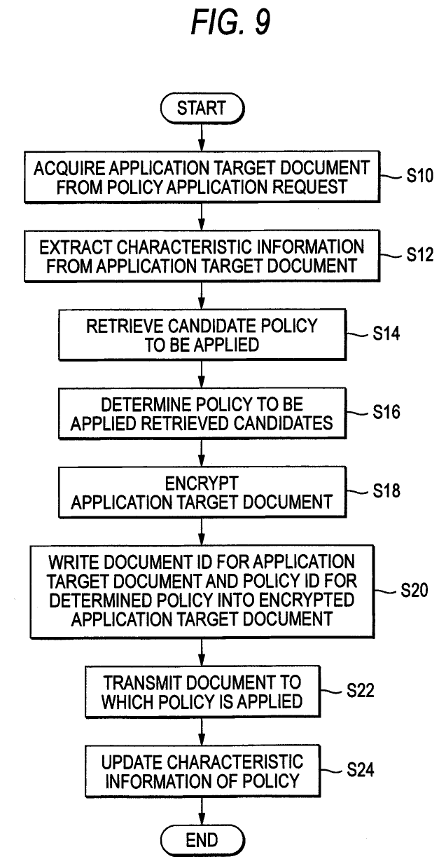

First, a description will be given of an example of the processing in a case where a policy is applied to a document to which the policy is not applied yet. In the client 20, when the input reception unit 22 receives the input from the user which specifies the application target document and instructs the application of the policy, the policy application request unit 202 in the document operation application 200 transmits the policy application request including the application target document to the policy server 10. The policy server 10 having received the policy application request starts processes in the procedure exemplified in FIG. 9.

Referring to FIG. 9, the policy application unit 106 firstly acquires the application target document included in the policy application request received from the client 20 (step S10). The policy application unit 106 passes the acquired application target document to the candidate policy retrieval unit 108 and, at the same time, requests the retrieval of candidate policies to be applied. The candidate policy retrieval unit 108 requests the document characteristic information extraction unit 110 to extract the characteristic information from the application target document.

The document characteristic information extraction unit 110 extracts the characteristic information from the application target document (step S12). In the present example, the document characteristic information extraction unit 110 extracts the characteristic information of the application target document by referring to the setting of the index words (see FIG. 5) and determining the appearance frequency of each index word in the application target document. For example, in a case where n index words are set, when the appearance frequency of the i-th index word in the application target document D is f_{i•D}, the characteristic information λ (D) of the application target document D to be extracted is represented as follows:

λ(D)=(f_{1•D}, f_{2•D}, . . . , f_{n•D}).

The document characteristic information extraction unit 110 returns the extracted characteristic information of the application target document to the candidate policy retrieval unit 108.

Next, the candidate policy retrieval unit 108 retrieves candidate policies to be applied to the application target document from among policies in the policy information DB 100 by using the characteristic information of the application target document extracted by the document characteristic information extraction unit 110 (step S14). In the step S14, for example, the candidate policy retrieval unit 108 selects the candidate policies according to the result of comparison between the characteristic information of the application target document and the characteristic information of each policy in the policy information DB 100 (see FIG. 4). For example, a preset number of policies are selected as candidate policies, starting with the policy having the characteristic information determined to be closest to that of the application target document, in order of increasing distance between the characteristic information of each candidate policy and that of the application target document. The determination of the “closeness” of the characteristic information is performed by using Euclidean distance in the present example. For example, by using the characteristic information η (P) of the policy P represented by the foregoing Expressions (1) and (2) and the characteristic information λ (D) of the application target document D, the Euclidean distance d_{D, p} between the characteristic information of the application target document D and that of the policy P is determined according to following Expression (3):

$${d}_{D , P} = \sqrt{{\sum }_{i = 1}^{n} {( {f}_{i , D} - {F}_{i} )}^{2}} . \qquad ( 3 )$$

The candidate policy retrieval unit 108 determines the Euclidean distance to the characteristic information λ (D) of the application target document for each of the policies in the policy information DB 100 according to Expression (3). Subsequently, for example, the preset number of policies are selected as the candidate policies to be applied in order of increasing value of the determined Euclidean distance, starting with the policy with the smallest value. Alternatively, policies each having the determined value of the Euclidean distance not more than a preset threshold value may be selected as the candidate policies to be applied. The candidate policy retrieval unit 108 passes the retrieved candidate policies to the policy application unit 106.

The policy application unit 106 having received the candidate policies from the candidate policy retrieval unit 108 determines one policy to be applied to the application target document from among the received candidate policies (step S16). This determination is performed according to, e.g., a selection by the user. When the determination is performed according to the selection by the user, for example, the policy application unit 106 transmits a list of the candidate policies to the client 20, the display unit 24 is caused to display the list in the client 20 having received the list, and the selection by the user is received via the input reception unit 22. When the user selects one policy from the list, information indicative of the result of the selection is returned from the client 20 to the policy server 10, and the policy application unit 106 determines the policy indicated by the result of the selection as the policy to be applied to the application target document.

When the policy to be applied is determined, the policy application unit 106 instructs the document encryption unit 112 to encrypt the application target document (step S18). The encryption in the step S18 is performed by a method in which the decryption can be executed only by the document encryption/decryption unit 210 provided in the document operation application 200 of the client 20. Thereafter, the policy application unit 106 generates the document ID for the application target document, and writes the document ID and the policy ID for the policy determined in the step S16 into the encrypted document (step S20). The application target document which is encrypted and the document ID and the policy ID are written into is transmitted as the document to which the policy is applied from the policy application unit 106 to the client 20 (step S22). The policy application unit 106 also registers the policy ID for the policy determined in the step S16 and the characteristic information of the application target document in the document information DB 102 in association with the document ID for the application target document. It is to be noted that the timing of generation of the document ID for the application target document may also be set before the encryption of the application target document.

When the policy application unit 106 applies the policy to the application target document, the policy characteristic information generation unit 114 performs a process for updating the characteristic information of the applied policy (the policy determined in the step S16) by using the characteristic information of the application target document (step S24).

A description will be given hereinafter of a specific example of the process in the step S24. When it is assumed that the characteristic information λ (D)=(f_{1•D}, f_{2•D}, . . . , f_{n•D}) of the application target document D and the present characteristic information η (P)=(F₁, F₂, . . . , Fₙ) of the policy P applied to the application target document D are satisfied, and the number of documents to which the policy P was applied before the policy P is applied to the application target document D is m, the policy characteristic information generation unit 114 determines a value of each element F′ᵢ in a vector of the characteristic information η′(P)=(F′₁, F′₂, . . . , F′ₙ) of the policy P after the update according to following Expression (4):

$${F}_{i}^{′} = \frac{{F}_{i} \times m + {f}_{i , D}}{m + 1} . \qquad ( 4 )$$

When the update process of the characteristic information of the policy (step S24) is ended, the processes in the procedure in the example of FIG. 9 are ended.

In the procedure exemplified in FIG. 9, the process for determining one policy as the policy to be applied from among a plurality of candidate policies retrieved by the candidate policy retrieval unit 108 in the step S14 (the step S16) is performed. However, the candidate policy retrieval unit 108 may return only one candidate policy as the retrieval result to the policy application unit 106. For example, the candidate policy retrieval unit 108 may return one policy having the characteristic information closest to that of the application target document to the policy application unit 106 as the retrieval result. In the case of this example, with the one policy being adopted as the policy to be applied, the step S16 may be omitted and the processes in and subsequent to the step S18 may be performed. Alternatively, information for inquiring of the user whether or not the one policy is actually to be applied to the application target document may be transmitted to the client 20 in the step S16. Subsequently, an instruction of the user inputted in the client 20 is received from the client 20, and the processes in and subsequent to the step S18 may be performed only when the instruction of the user instructs the application of the one policy to the application target document.

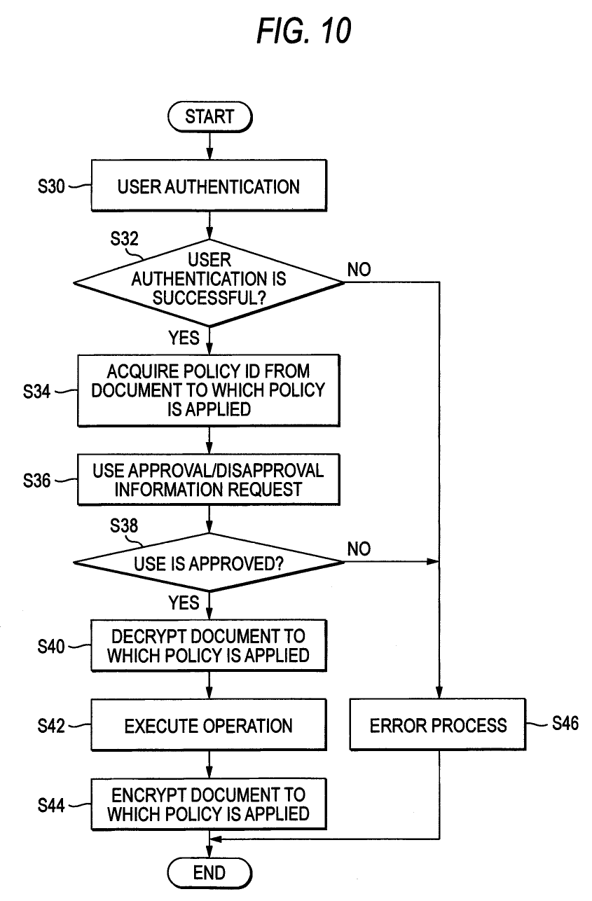

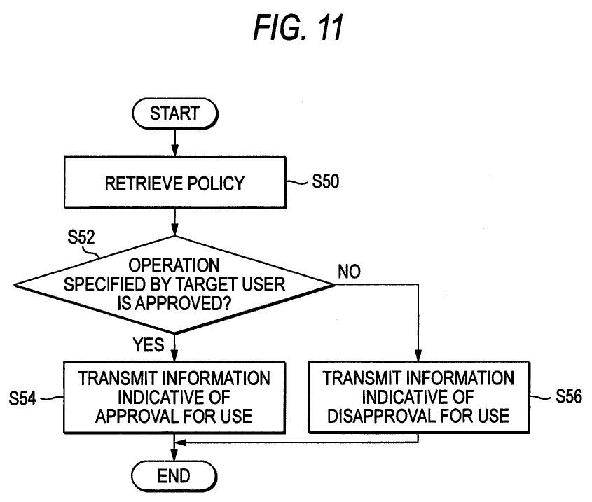

Next, with reference to FIGS. 10 and 11, a description will be given of an example of processing when the user uses the document to which the policy is applied.

FIG. 10 is a flow chart illustrating an example of the procedure of the processing in the client 20 at the time of use of the document to which the policy is applied. For example, the processes in the procedure exemplified in FIG. 10 are started when the input reception unit 22 receives the inputs of the document to which the policy is applied that the user wishes to use and the type of the operation that the user wishes to execute with respect to the document of concern, and passes the inputs to the document operation application 200 in the client 20.

Referring to FIG. 10, the user authentication request unit 204 of the document operation application 200 in the client 20 firstly makes the user authentication request to the user authentication server 30 (step S30). The user authentication request includes, e.g., the authentication information (e.g., the user ID and the password) inputted by the user. The user authentication server 30 performs the user authentication by using the authentication information included in the user authentication request from the client 20, and returns information indicative of a success or an error of the user authentication to the client 20.

When the user authentication request unit 204 receives the information indicative of the success of the user authentication from the user authentication server 30 (YES in the step S32), the process flow advances to a step S34, while when the user authentication request unit 204 receives the information indicative of the error thereof (NO in the step S32), an error process (step S46) is performed. In the error process, for example, the document operation application 200 causes the display unit 24 to display information showing a content of the error (the error of the user authentication in this case).

In the step S34, the use approval/disapproval information request unit 208 acquires the policy ID included in the document to which the policy specified by the user is applied. Then, the use approval/disapproval information request unit 208 makes the use approval/disapproval information request including the policy ID acquired in the step S34, the user ID inputted in the user authentication process (step S30), and the information indicative of the type of the operation wished to be executed to the policy server 10 (step S36).

With reference to FIG. 11, a description will be given of an example of the procedure of processing executed in the policy server 10 having received the use approval/disapproval information request in the step S36 of FIG. 10. The use approval/disapproval information generation unit 116 in the policy server 10 passes the policy ID included in the use approval/disapproval information request received from the client 20 to the policy retrieval unit 118 and, at the same time, requests the retrieval of the policy indicated by the policy ID of concern. In response to this request, the policy retrieval unit 118 retrieves the content of the policy (see FIG. 3) registered in the policy information DB 100 in association with the policy ID of concern (step S50). The policy retrieval unit 118 passes the policy content as the retrieval result to the use approval/disapproval information generation unit 116.

The use approval/disapproval information generation unit 116 checks the policy content received form the policy retrieval unit 118 against the user ID and the type of the operation in the use approval/disapproval information request to determine whether or not the specified type of the operation is approved for the execution of a target user (step S52). For example, in a case where the user ID in the request corresponds to the “use area” set by the policy of concern, the current date and time falls within the “valid period” associated with the corresponding “use area”, and the type of the operation in the request is included in the “approved function list” associated with the corresponding “use area”, it is determined that the execution of the operation is approved, and it is determined that the execution of the operation is not approved in the other cases. As one specific example of such a case, in a case where the policy received from the policy retrieval unit 118 is a policy indicated by the policy ID “AA34D3” in the table in the example of FIG. 3, it is judged whether or not the user ID in the use approval/disapproval information request corresponds to the “name of organization: personnel department” or “user ID: 17839” set in the item of “use area” and, when the user ID does not corresponds thereto, it is determined that the execution of the operation (i.e., use of the document) is not approved. It maybe determined by, e.g., inquiring of the user authentication server 30 whether or not the user indicated by the user ID in the request belongs to a certain group. In addition, for example, in the example of the policy indicated by the policy ID “AA34D3”, when the ID in the use approval/disapproval information request corresponds to the “name of organization: personnel department”, the current date and time falls within a period “from Mar. 1, 2007 to Aug. 31, 2007” set in the “valid period”, and the type of the operation in the use approval/disapproval information request is the “reading of electronic document” included in the “approved function list”, it is determined that the execution of the operation is approved.

When it is determined that the type of the operation in the request is approved for the execution of the user indicated by the user ID in the use approval/disapproval information request (YES in the step S52), the use approval/disapproval information generation unit 116 generates information indicative of approval for the use and transmits the information to the client 20 (step S54). When it is determined that the type of the operation in the request is not approved for the execution of the target user (NO in the step S52), the use approval/disapproval information generation unit 116 generates information indicative of disapproval for the use and transmits the information to the client 20 (step S56). After the step S54 or the step S56, the processes in the procedure in the example of FIG. 11 are ended.

Returning back to the reference to FIG. 10, in the client 20 having received the information indicative of approval for the use or the information indicative of disapproval for the use from the policy server 10, processes in and subsequent to the step S38 are performed.

When the client 20 receives the information indicative of approval for the use from the policy server 10 (YES in the step S38), the document operation unit 206 of the document operation application 200 requests the document encryption/decryption unit 210 to decrypt the document to which the policy is applied which is to be operated (step S40). Then, the document operation unit 206 executes the type of the operation specified by the user with respect to the decrypted document to which the policy is applied (step S42). After the execution of the operation, the document operation unit 206 requests the document encryption/decryption unit 210 to encrypt the document to which the policy is applied (step S44).

On the other hand, when the client 20 receives the information indicative of disapproval for the use from the policy server 10 (NO in the step S38), the document operation application 200 performs the error process (step S46). After the step S44 or the step S46, the processes in the procedure exemplified in FIG. 10 are ended.

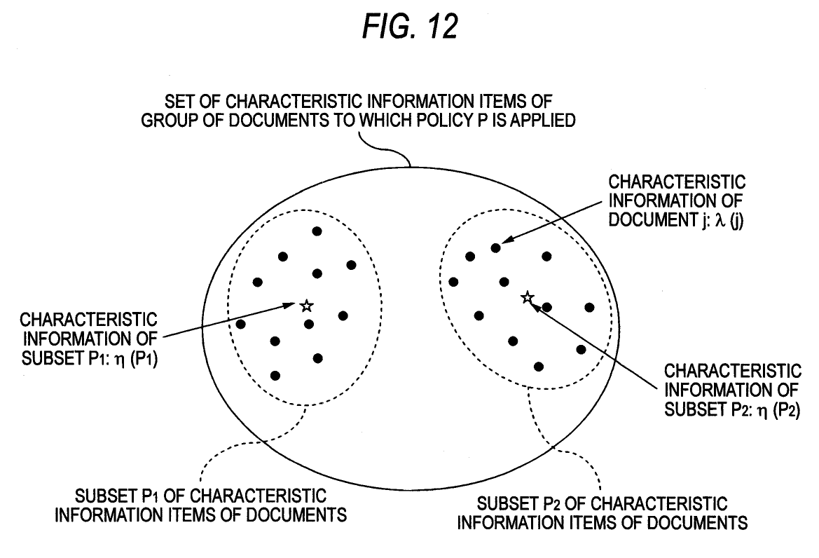

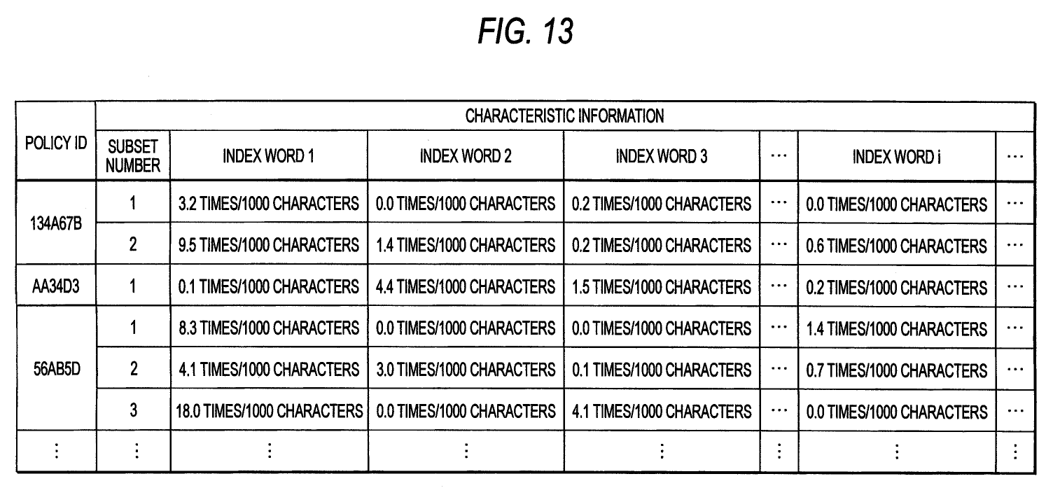

In the example of the embodiment described thus far, for each policy, one characteristic information η (P) is determined by calculating the average of a set of the characteristic information items of the documents to which the policy (P) is applied. In an example of another embodiment, as exemplified in FIG. 12, the set of the characteristic information items of the documents to which the policy P is applied may be divided into a plurality of subsets, and the characteristic information maybe determined for each subset. In the case of the present example, the characteristic information of each policy registered in the policy information DB 100 has, e.g., a content shown in the table of FIG. 13.

Referring to FIG. 13, the characteristic information of each policy is registered for each subset shown in the item of a “subset number”. For example, the policy indicated by the policy ID “134A67B” in the table in the example of FIG. 13 has the characteristic information of a subset “1” determined from the characteristic information items of the documents included in the subset indicated by the subset number “1”, and the characteristic information of a subset “2” determined from the characteristic information items of the documents included in the subset indicated by the subset number “2”.

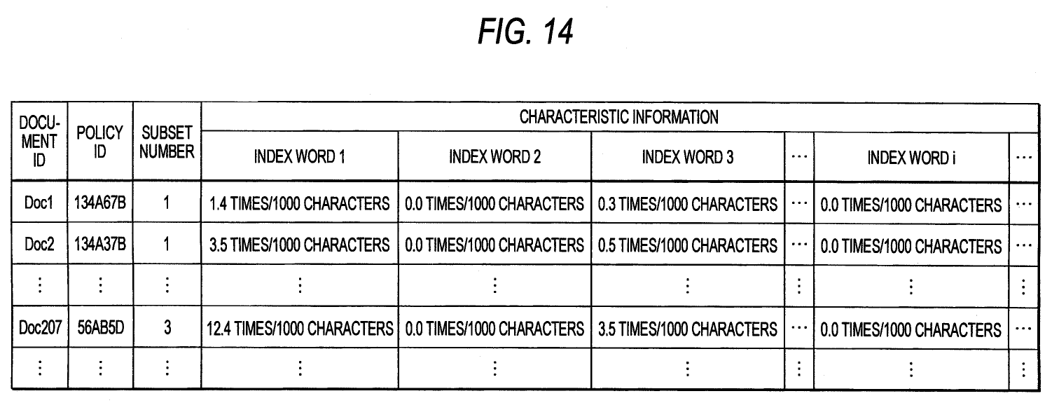

Since the characteristic information for each subset of the characteristic information items of the documents to which each policy is applied (hereinafter may referred to as simply a “subset of each policy”) is determined, in the example of the present embodiment, in addition to the policy ID applied to each document, the document information DB 102 stores the number of the subset to which the document (the characteristic information thereof) belongs. FIG. 14 shows one example of a data content of the document information DB 102 in the example of the present embodiment. The characteristic information for each subset of each policy is obtained by extracting records each having a combination of the same policy ID and the same subset number in the document information DB 102 and calculating the average of each index word in the extracted records.

More general description of the characteristic information of each policy in the example of the present embodiment described thus far is as follows. When there are n index words and m_{Pk} documents belonging to a subset Pₖ of the subset number k of a certain policy P, and the appearance frequency of the i-th index word in the j-th document in the subset Pₖ is f_{i•j}, the characteristic information η (Pₖ) of the subset Pₖ of the subset number k of the certain policy P is represented as following Expression (5):

$$\begin{matrix}η ( {P}_{k} ) = ( {F}_{1} , {F}_{2} , … , {F}_{n} ) \\ wherein & ( 5 ) \\ {F}_{i} = \frac{{\sum }_{j = 1}^{{m}_{{P}_{k}}} {f}_{i , j}}{{m}_{{P}_{k}}} . & ( 6 )\end{matrix}$$

In the example of the present embodiment, not all of the policies need to have a plurality of subsets. For example, the policy indicated by the policy ID “AA34D3” in the table in the example of FIG. 13 has only one subset of the subset number “1”. Similarly to the above-mentioned embodiment described with reference to FIG. 4, the characteristic information of the policy indicated by the policy ID “AA34D3” is determined by calculating the average of values of all elements in the set of the characteristic information items of the documents to which the policy is applied.

As a method for dividing the set of the characteristic information items λ (j) of the documents j to which the policy P is applied into the plurality of subsets, for example, any of various clustering methods each of which is known as a technique for classifying a set of data items into subsets by using dissimilarity (distance) between the data items may be adopted. Representative clustering methods include, e.g., a k-means method and agglomerative hierarchical clustering which will be described below.

(k-Means Method)

In the k-means method, when a set U (hereinafter referred to as “an input data set U”) to be divided into clusters is divided into k clusters (subsets), a division that minimizes an objective function (Expression (7)) indicative of appropriateness of the division is determined.

$${\sum }_{i = 1}^{k} {\sum }_{x ∈ {C}_{i}} {( D ( x , {c}_{i} ) )}^{2} \qquad ( 7 )$$

wherein cᵢ is referred to as a centroid of a cluster Cᵢ, and represented by following Expression (8):

$${c}_{i} = \frac{1}{\vert {C}_{i} \vert} {\sum }_{x ∈ {C}_{i}} x . \qquad ( 8 )$$

When the input data set U and the number of clusters k into which the input data set U is divided are given, processing in accordance with the following steps is performed.

1. The input data U is randomly divided into k initial clusters.

2. The centroid cᵢ of each of the clusters Cᵢ is determined.

3. Every element x in the input data U is allocated to the cluster Cᵢ which provides the smallest distance D (x. cᵢ) to the centroid cᵢ of each cluster Cᵢ.

4. When there is no further change observed in the allocation of the elements to the clusters or the preset number of times of repetition of the processing is exceeded, the processing is ended and, in other cases, the processing returns back to the step 2.

By executing the above-mentioned processing in accordance with the steps 1 to 4 with respect to different initial clusters plural times, the division that minimizes the objective function of Expression (7) is obtained.

### (Agglomerative Hierarchical Clustering)

In the agglomerative hierarchical clustering, when the input data set U is given, a state where there are N clusters each including only one element of the input data set U is firstly generated as an initial state (i.e., N is the number of elements of the input data set). Starting from this initial state, from a distance D (x₁, x₂) between elements x₁ and x₂ of the input data set U, a distance D (C₁, C₂) between clusters C₁ and C₂ which respectively include the elements x₁ and x₂ is calculated, and processing for successively merging clusters having the smallest calculated distance therebetween is repeated until all elements of the input data set are merged into one cluster, whereby a hierarchical structure is obtained. For the distance D (x₁, x₂) between the elements, for example, the Euclid distance is used. As examples of a distance function for determining the distance D (C₁, C₂) between the clusters, functions shown below are proposed.

### (Nearest Neighbor Method or Single Linkage Method)

$$D ( {C}_{1} , {C}_{2} ) = {min}_{{x}_{1} ∈ {C}_{1} , {x}_{2} ∈ {C}_{2}} D ( {x}_{1} , {x}_{2} )$$

### (Furthest Neighbor Method or Complete Linkage Method)

$$D ( {C}_{1} , {C}_{2} ) = {max}_{{x}_{1} ∈ {C}_{1} , {x}_{2} ∈ {C}_{2}} D ( {x}_{1} , {x}_{2} )$$

### (Group Average Method)

$$D ( {C}_{1} , {C}_{2} ) = \frac{1}{{n}_{1} {n}_{2}} {\sum }_{{x}_{1} ∈ {C}_{1}} {\sum }_{{x}_{2} ∈ {C}_{2}} D ( {x}_{1} , {x}_{2} )$$

### (Ward Method)

$$D ( {C}_{1} , {C}_{2} ) = E ( {C}_{1} ⋃ {C}_{2} ) - E ( {C}_{1} ) - E ( {C}_{2} )$$

$$wherein$$

$$E ( {C}_{i} ) = {\sum }_{x ∈ {C}_{i}} {( D ( x , {c}_{i} ) )}^{2}$$

$${c}_{i} = \frac{1}{\vert {C}_{i} \vert} {\sum }_{x ∈ {C}_{i}} x .$$

As an example of a document in which clustering methods are described, S. Miyamoto, “Introduction to Cluster Analysis: Theory and Applications of Fuzzy Clustering”, Morikita-Shuppan, 1999 can be listed.

By applying the above-mentioned methods in the various examples with the set {λ (1), λ (2), . . . , λ (j), . . . λ (mₚ)} of the characteristic information items λ (j) of the documents to which the policy P is applied as the input data set, the set of the characteristic information items λ (j) of the documents can be divided into subsets each including the characteristic information items similar to each other.

A description will be given hereinafter of an example of processing in the policy server 10 when the policy is newly applied in the example of the present embodiment described above with reference to FIGS. 12 to 14. In the present example as well, the overall procedure of the processing in the policy server 10 is similar to the above-mentioned flow chart exemplified in FIG. 9. However, in the present example, the candidate policy retrieval unit 108 of the policy server 10 performs a comparison between the characteristic information λ (D) of the application target document D and the characteristic information η (Pₖ) registered for each subset Pₖ of the characteristic information items of the documents to which each policy P is applied in the process for retrieving the candidate policies to be applied to the document (the step S14). In other words, the Euclid distance to the characteristic information λ (D) of the application target document D is determined for each characteristic information represented by one row in the table in the example of FIG. 13. Then, starting from the characteristic information item η (Pₖ) having the smallest determined Euclid distance, the preset number of the characteristic information items η (Pₖ) are selected in order of increasing Euclid distance, or the characteristic information items η (Pₖ) each having a value not more than the preset threshold value are selected, and the policies P in correspondence to the selected characteristic information items η (Pₖ) are adopted as the candidate policies to be applied. At this time, when, among the selected characteristic information items η (Pₖ), a plurality of them are the characteristic information items of different subsets of the same one policy P, the candidate policies to be applied include the one policy. When only one candidate policy to be applied is returned as the retrieval result in the step S14, one policy in correspondence to η (Pₖ) having the smallest determined Euclid distance may be adopted as the retrieval result.

After the step S14, in the example of the present embodiment as well, the processes from the step 16 (determination of the policy to be applied) to the step S22 (transmission of the document to which the policy is applied) are performed in the same manner as those described above.

In the process for updating the characteristic information of the policy in the step S24, with regard to the policy P applied to the application target document D, the characteristic information of the subset Pₖ having the characteristic information items η (Pₖ) selected since the Euclid distance to the characteristic information λ (D) of the application target document D satisfies the condition in each example described above (the smallest distance, a specific distance from the smallest distance, or not more than the preset threshold value) in the step S14 is updated. In other words, the characteristic information η (Pₖ) of the subset Pₖ is updated by having the application target document D as a document included in the subsets Pₖ. By assuming that the characteristic information λ (D)=(f_{1•D}, f_{2•D}, . . . , f_{n•D}) of the application target document D and the current characteristic information η (Pₖ)=(F₁, F₂, . . . , Fₙ) of the subset Pₖ of the applied policy P are satisfied, and the number of documents included in the subset Pₖ before the policy P is applied to the application target document is m, the characteristic information after the update η′ (Pₖ)=(F′₁, F′₂, . . . , F′ₙ) may be determined in accordance with the above-mentioned Expression (4). When the policy application unit 106 registers the application target document D in the document information DB 102, the policy application unit 106 registers the policy ID for the policy P, the subset number k of the subset Pₖ of the policy P, and the characteristic information λ (D) of the application target document D in association with the document ID for the application target document D.

With regard to the applied policy P, when respective characteristic information items η (Pₗ) and η (Pₘ) of a plurality of subsets Pₗ and Pₘ of the policy P are selected as the characteristic information items satisfying the conditions in the step S14, for example, of the characteristic information items η (Pₗ) and η (Pₘ), the characteristic information of the subset with a smaller Euclid distance to the characteristic information λ D of the application target document D may be updated in a manner similar to the foregoing.

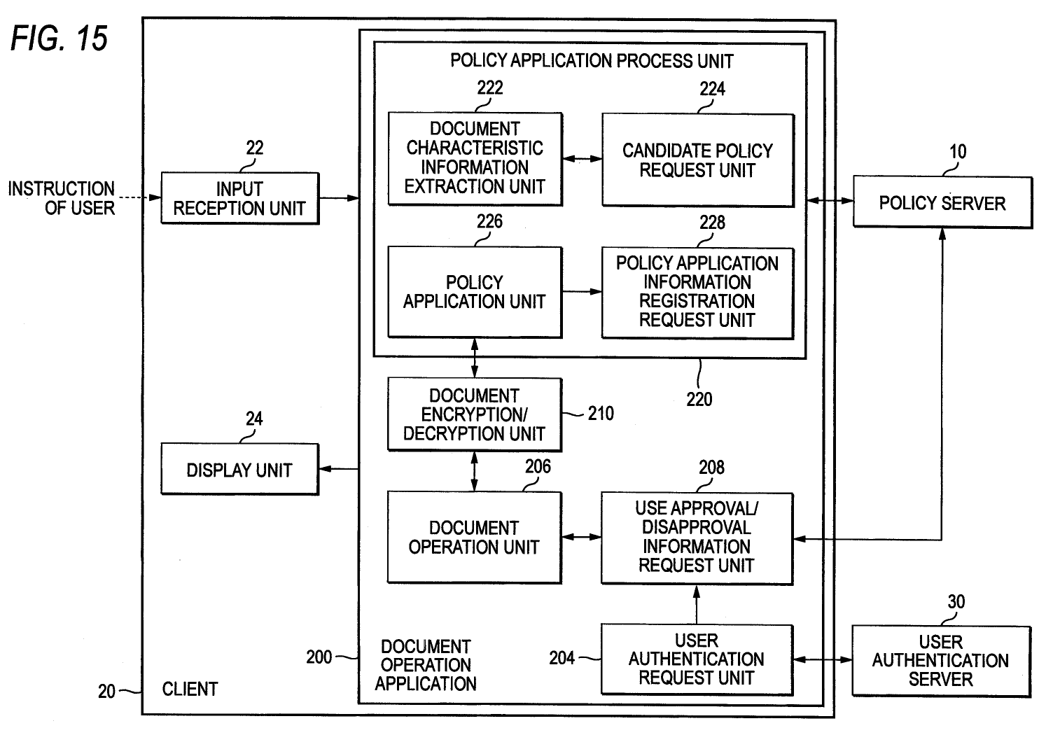

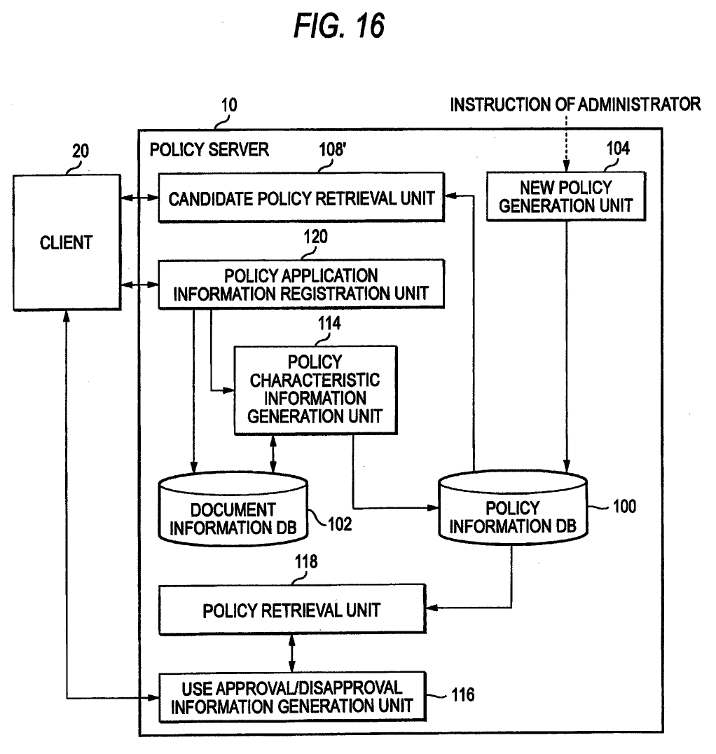

Thus, in various examples of the embodiments described with reference to FIGS. 1 to 14, when the policy is applied to the document, the characteristic information of the application target document is extracted in the policy server 10, and the retrieval of the candidate policies is performed by using the extracted characteristic information. In addition, in the example of another embodiment, the characteristic information of the application target document is extracted in the client 20 and transmitted to the policy server 10, and the policy server 10 performs the retrieval of the candidate policies by using the characteristic information of the application target document received from the client 20. Examples of schematic internal structures of the client 20 and the policy server 10 in the example of this embodiment are respectively shown in FIGS. 15 and 16.

First, a description will be given of the example of the structure of the client 20 in the example of the present embodiment with reference to FIG. 15. In FIG. 15, the detailed description of the components which are the same as those of the client 20 exemplified in FIG. 8 will be omitted by retaining the same reference numerals of FIG. 8. The client 20 in the example of FIG. 15 is different from the client 20 in the example of FIG. 8 in that a policy application process unit 220 is provided in the document operation application 200 instead of the policy application request unit 202 (FIG. 8).

The policy application process unit 220 performs a process for applying the policy to the document. The policy application process unit 220 includes a document characteristic information extraction unit 222, a candidate policy request unit 224, a policy application unit 226, and a policy application information registration request unit 228.

The document characteristic information extraction unit 222 extracts, from the application target document specified by the user via the input reception unit 22, the characteristic information of the document. For example, by storing a table for setting the index words such as the one in the example of FIG. 5 in advance in a memory device (not shown) which can be accessed by the client 20, referring to the table for setting in the document characteristic information extraction unit 222, and retrieving text data of the application target document D for the index word indicated by each number, the appearance frequency f_{i•D} of each index word i is determined. Then, the document characteristic information extraction unit 222 adopts the determined appearance frequency of each index word as the characteristic information λ (D) of the application target document D.

The candidate policy request unit 224 makes a candidate policy request for requesting candidate policies to be applied to the application target document to the policy server 10. This candidate policy request includes the characteristic information λ (D) of the application target document D extracted by the document characteristic information extraction unit 222.

The policy application unit 226 performs a process for applying one policy selected from among the candidate policies provided from the policy server 10 in response to the candidate policy request performed by the candidate policy request unit 224 to the application target document. For example, after requesting the document encryption/decryption unit to encrypt the application target document, the policy application unit 226 generates the document ID for the application target document, and performs a process for writing the document ID and the policy ID for the selected policy into the encrypted application target document to generate the document to which the policy is applied. It is to be noted that the timing of generation of the document ID for the application target document may be set before the encryption of the application target document.

When the policy application unit 226 has performed the process for applying the policy to the application target document, the policy application information registration request unit 228 makes a request for registering the information related to the process in the policy server 10 to the policy server 10. For example, the policy application information registration request unit 228 transmits a registration request including the document ID for the application target document, the characteristic information of the application target document extracted by the document characteristic information extraction unit 222, and the policy ID for the policy applied to the application target document to the policy server 10. In response to the registration request, the information related to the application of the policy to the application target document is registered in the policy server 10.

Next, with reference to FIG. 16, a description will be given to an example of the structure of the policy server 10 in the example of the present embodiment. In FIG. 16, the detailed description of the components which are the same as those of the policy server 10 exemplified in FIG. 2 will be omitted by retaining the same reference numerals of FIG. 2.

A candidate policy retrieval unit 108′ retrieves candidate policies from the policy information DB 100 in response to the candidate policy request from the candidate policy request unit 224 of the client 20. For example, the candidate policy retrieval unit 108′ selects the candidate policies to be applied to the application target document based on a result of comparison between the characteristic information of the application target document included in the candidate policy request and the characteristic information of each policy registered in the policy information DB 100. The candidate policy retrieval unit 108′ returns the selected candidate policies to the client 20 as the retrieval result.

A policy application information registration unit 120 performs a process for registering information related to the application of the policy to the application target document in the document information DB 102 in response to the registration request from the policy application information registration request unit 228 of the client 20. For example, the policy application information registration unit 120 acquires the document ID for the application target document, the characteristic information of the application target document, and the policy ID for the applied policy from the registration request from the client 20, and registers the acquired policy ID and characteristic information in association with the acquired document ID in the document information DB (see FIG. 6).

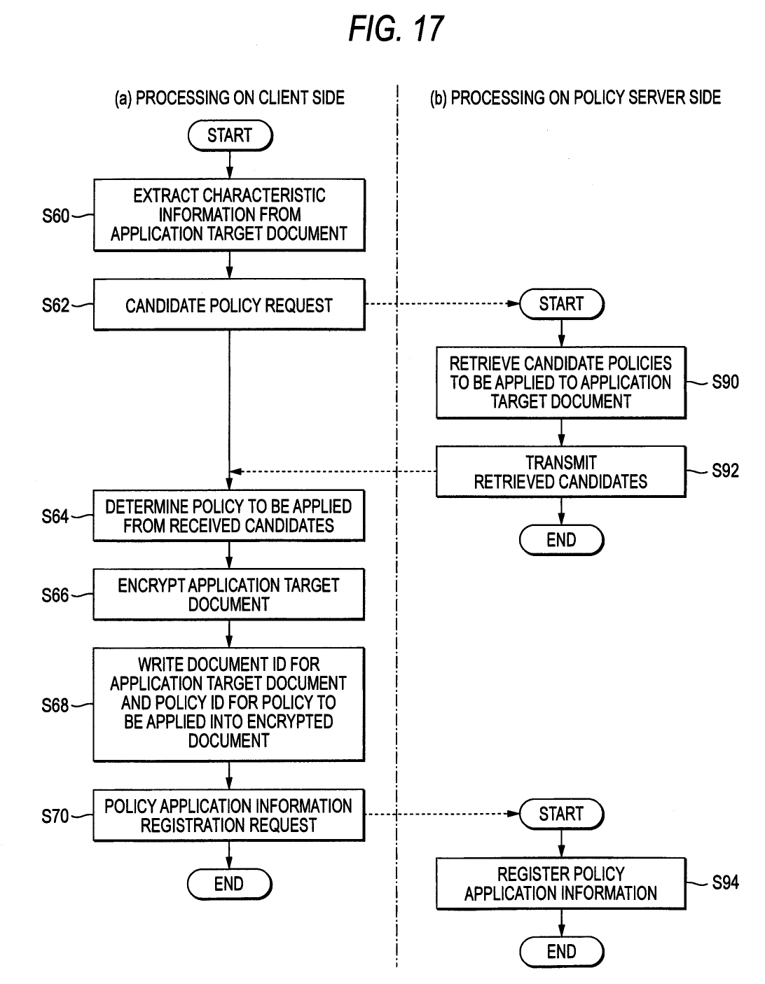

FIG. 17 is a flow chart showing an example of the procedure of the processing performed when the policy is applied to the document in the client 20 and the policy server 10 respectively exemplified in FIGS. 15 and 16.

Referring to FIG. 17, when the specification of the application target document by the user is received via the input reception unit 22 in the document operation application 200 of the client 20, the document characteristic information extraction unit 222 firstly extracts the characteristic information from the specified application target document (step S60). In the step S60 in the present example, the characteristic information λ (D)=(f_{1•D}, f_{2•D}, . . . , f_{n•D}) of the application target document D is extracted in the same manner as in the description with reference to the step S14 of FIG. 9 (f_{i•D} is the appearance frequency of the index word i). Next, the candidate policy request unit 224 transmits the candidate policy request including the characteristic information λ (D) of the application target document D extracted in the step S60 to the policy server 10 (step S62).

In the policy server 10 having received the candidate policy request, the candidate policy retrieval unit 108′ retrieves the candidate policies from the policy information DB 100 by using the characteristic information λ (D) of the application target document D included in the candidate policy request (step S90). The process for retrieving the candidate policies in the step S90 may be the same as the process by the candidate policy retrieval unit 108 described with reference to the step S14 of FIG. 9. The candidate policy retrieval unit 108′ transmits the candidate policies as the retrieval result to the client 20 (step S92). At this time, with regard to the candidate policies as the retrieval result, the candidate policy retrieval unit 108′ transmits, e.g., the content as shown in the table in the example of FIG. 3 to the client 20.

In the client 20 having received the candidate policies from the policy server 10, the policy application unit 226 in the document operation application 200 determines one policy from among the received candidate policies as the policy to be applied to the application target document (step S64). For example, the policy application unit 226 receives the selection of the user by causing the display unit 24 to display the received candidate policies, and determines the policy selected by the user as the policy to be applied. It is to be noted that, when there is only one candidate policy received from the policy server 10, the one policy may be determined as the policy to be applied.

When the policy to be applied is determined, the policy application unit 226 requests the document encryption/decryption unit 210 to encrypt the application target document (step S66). Next, the policy application unit 226 generates the document ID for the application target document, and writes the document ID and the policy ID for the policy determined in the step S64 into the encrypted application target document (step S68). Thereafter, the policy application information registration request unit 228 makes the registration request including the document ID for the application target document, the characteristic information of the application target document, and the policy ID for the applied policy to the policy server 10 (step S70). It is to be noted that the timing of generation of the document ID for the application target document may be set before the encryption of the application target document.

In the policy server 10 having received the registration request from the client 20, the policy application information registration unit 120 registers the information included in the registration request in the document information DB 102 (step S94). For example, the policy application information registration unit 120 registers the policy ID and the characteristic information in the registration request in association with the document ID in the registration request in the document information DB 102.

In the various examples of the embodiments described thus far, the characteristic information of each policy to be registered in the policy information DB 100 is generated by the policy characteristic information generation unit 114 of the policy server 10 by using the information associating each policy with the document to which the policy is applied before the start of execution of the process for newly applying the policy to the document (FIG. 9 or 17).

In addition, it is possible to perform the process for updating the characteristic information of the policy (see the step S24 in FIG. 9) with respect to policies newly applied to documents from the end of the previous update process to the present time for each preset period or at a timing specified by a system manager or the like, instead of performing the update process every time the policy is newly applied to the document as in the procedure in the example of FIG. 9. Alternatively, at the time when the number of documents to which policies are newly applied and which are registered in the document information DB 102 exceeds a preset threshold value, the characteristic information items of the policies applied to the newly registered documents may be updated.

Moreover, in the example of determining the characteristic information of each subset of the characteristic information items of the documents to which each policy is applied (see FIGS. 12 to 14), instead of or in addition to the above-mentioned process for updating the characteristic information of the subset Pₖ of the applied policy, a clustering process for dividing the set of the characteristic information items of the documents into subsets may be executed again, and the update process for recalculating the average of the characteristic information items of the documents maybe performed for each newly generated subset. The re-execution of the clustering process and the recalculation of the characteristic information for each subset associated therewith may be executed for each preset period or at a timing specified by the system manager or the like. For example, the re-execution of the clustering process is set so as to be performed during a time period in which a processing load of the policy server 10 is expected to be relatively small (for example, at night time when the number of system users is small).

Furthermore, the foregoing has described the various examples of the embodiments by taking the case where the appearance frequency of the preset index word is used as the characteristic information of the document or the policy as an example. However, other types of the appearance frequency of the index word in the document may be used as the characteristic information of the document as long as the information represents the characteristic of the document. For example, instead of the appearance frequencies of the index words in the entire document, the appearance frequency of the index word in the first half or the second half of the document may be used as one element in the vector of the characteristic information. In addition, for example, when a document according to a specific form is processed, it can be considered that whether or not a specific keyword is included in a preset element in the form is used as one element of the characteristic information (for example, a value of 0 or 1). Further, for example, when a document including an abstract of the content of the document or the title as attributive information of the document is processed, it can be considered that whether or not a specific keyword is included in the abstract or the title is used as one element of the characteristic information.

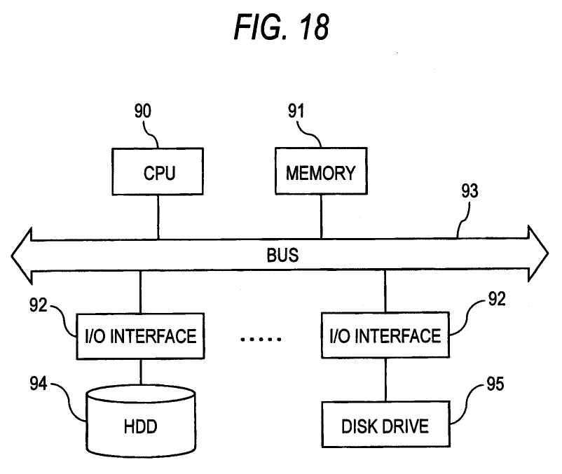

The policy server 10 in the various examples of the embodiments described above is typically implemented by executing a program in which the functions or processing contents of the individual components of the policy server 10 are written in a mainframe computer. As shown in FIG. 18, the computer has, e.g., a circuit structure in which a CPU (central processing unit) 90, a memory (primary storage) 91, and various I/O (input/output) interfaces 92 are connected to each other as hardware via a bus 93. To the bus 93, for example, a disk drive 95 for reading portable non-volatile recording media of various specifications such as a HDD (hard disk drive) 94, a CD, a DVD, and a flash memory is connected via the I/O interfaces 92. The drive 94 or 95 functions as an external storage device to the memory. The program with the processing content in the embodiments written wherein is stored in a fixed storage device such as the HDD 94 or the like via the recording medium such as the CD, the DVD, or the like, or via a network and installed in the computer. The program stored in the fixed storage device is read into the memory and executed by the CPU, whereby the processing in the embodiments is implemented. The same applies to the client 20.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An information processing apparatus comprising:
a storage that associates each of a plurality of pieces of use limitation information, which defines a policy for limitation on use of each of a plurality of documents, with a characteristic information, which represents a characteristic of each of the plurality of pieces of use limitation information and is determined based on a first document characteristic information acquired from each of the plurality of documents of which the use is limited according to the plurality of pieces of use limitation information, and that stores each of the plurality of pieces of use limitation information and the characteristic information, which are associated with each other; and
a selection unit that refers to the storage, and that selects, based on a result of comparison between a second document characteristic information of a document acquired from a specified document specified by and in response to an instruction specifying a document for which the policy for limitation on use is to be determined and the characteristic information associated with each of the plurality of pieces of use limitation information stored in the storage, a candidate for use limitation information to be used for the limitation on use of the specified document from the plurality of pieces of use limitation information.

2. The information processing apparatus as claimed in claim 1,
wherein
the first document characteristic information and the second document characteristic information are values representing a characteristic related to a content of the document.

3. The information processing apparatus as claimed in claim 1,
wherein
the characteristic information stored in the storage in association with each of the plurality of pieces of the use limitation information is an average of characteristic information of each of the plurality of documents of which use is limited according to the plurality of pieces of use limitation information.

4. The information processing apparatus as claimed in claim 1,
wherein
the candidate for the use limitation information selected by the selection unit includes at least the use limitation information associated with characteristic information which is closest to characteristic information of the specified document among the plurality of pieces of use limitation information.

5. The information processing apparatus as claimed in claim 1,
wherein
the characteristic information stored in the storage in association with each of the plurality of pieces of the use limitation information includes a characteristic information for each subset obtained by dividing a set of the plurality of documents of which use is limited according to each of the plurality of pieces of use limitation information in accordance with the characteristic information of each of the plurality of documents, and
the characteristic information for each subset is determined based on characteristic information of each of the plurality of documents included in the subset.

6. The information processing apparatus as claimed in claim 5,
wherein
the characteristic information for each subset is an average of characteristic information of each of the plurality of documents included in the subset.

7. The information processing apparatus as claimed in claim 5,
wherein
the selection unit selects the candidate for the use limitation information based on a result of comparison between the characteristic information of the specified document and the characteristic information for each subset included in the characteristic information associated with each of the plurality of pieces of use limitation information.

8. The information processing apparatus as claimed in claim 1, further comprising:
a registration unit that determines, with regard to the use limitation information which is included in the candidate selected by the selecting unit and is decided to be used for the limitation on use of the specified document, the characteristic information of each of the plurality of pieces of the use limitation information by further considering the characteristic information of the specified document, and that registers the determined characteristic information in association with the decided use limitation information in the storage.

9. An information processing method comprising:
associating each of a plurality of pieces of use limitation information, which defines a policy for limitation on use of each of a plurality of documents, with a characteristic information, which represents a characteristic of each of the plurality of pieces of use limitation information and is determined based on a first document characteristic information acquired from each of the plurality of documents of which the use is limited according to the plurality of pieces of use limitation information, and storing each of the plurality of pieces of use limitation information and the characteristic information, which are associated with each other; and
referring to each of the plurality of pieces of use limitation information and the characteristic information, which are associated with each other, and selecting, based on a result of comparison between a second document characteristic information of a document acquired from a specified document specified by and in response to an instruction specifying a document for which the policy for limitation on use is to be determined and the characteristic information associated with each of the plurality of pieces of use limitation information stored in the storage, a candidate for use limitation information to be used for the limitation on use of the specified document from the plurality of pieces of use limitation information.

10. A computer readable medium storing a program causing a computer to execute a process for performing information processing, the process comprising:
associating each of a plurality of pieces of use limitation information, which defines a policy for limitation on use of each of a plurality of documents, with a characteristic information, which represents a characteristic of each of the plurality of pieces of use limitation information and is determined based on a first document characteristic information acquired from each of the plurality of documents of which the use is limited according to the plurality of pieces of use limitation information, and storing each of the plurality of pieces of use limitation information and the characteristic information, which are associated with each other; and
referring to each of the plurality of pieces of use limitation information and the characteristic information, which are associated with each other, and selecting, based on a result of comparison between a second document characteristic information of a document acquired from a specified document specified by and in response to an instruction specifying a document for which the policy for limitation on use is to be determined and the characteristic information associated with each of the plurality of pieces of use limitation information stored in the storage, a candidate for use limitation information to be used for the limitation on use of the specified document from the plurality of pieces of use limitation information.
